(19) United States
(12) Patent Application Publication
(10) Pub. No.: US 2023/0196400 A1
(43) Pub. Date: Jun. 22, 2023

(54) PRIVILEGE GRANTING SYSTEM, PRIVILEGE GRANTING PROGRAM, AND PRIVILEGE GRANTING METHOD

(71) Applicant: Yu MAEDA, Tokyo (JP)

(72) Inventor: Yu MAEDA, Tokyo (JP)

(21) Appl. No.: 17/923,397

(22) PCT Filed: Apr. 30, 2021
(86) PCT No.: PCT/JP2021/017269

§ 371 Date: Nov. 4, 2022

(30) Foreign Application Priority Data
May 7, 2020 (JP) 2020-082271

(51) Int. Cl. G06Q 30/0207; G06Q 30/0235

(52) U.S. Cl. CPC G06Q 30/0224; G06Q 30/0239; G06Q 30/0235

(57) ABSTRACT

An object of the present invention is to provide a special gift granting system capable of granting a special gift to a user on the basis of a history of browsing store information by the user.

The invention relates to a special gift granting system for granting a special gift to a user, the special gift granting system comprising a user terminal and a server apparatus capable of communication connection with a user terminal, wherein the user terminal includes a browsing request transmitter that transmits a store information browsing request to the server apparatus; a special gift request information acquirer that acquires a special gift request information for receiving a special gift at a store; and a special gift request information transmitter that transmits the acquired special gift request information to the server apparatus, and the server apparatus includes: a history information storage that stores a history related to receiving the browsing request from the user terminal or transmitting the store information to the user terminal; a special gift request information receiver that receives a special gift request information from the user terminal; and a first special gift granting enabler that enables granting of the special gift to the user when the it is determined that the history corresponding to the received user identification information is stored in the history information storage.

### TECHNICAL FIELD

The invention relates to a special gift granting system, a special gift granting program, and a special gift granting method.

### BACKGROUND ART

Conventionally, it has been widely practiced that a business operator who provides services and commodities by using an actual store posts information on services and commodities in the store, discount coupons usable at the time of purchasing services and commodities, or the like on an information posting site such as a gourmet information site or a hotel reservation site on the internet, and uses them for attracting customers and marketing. However, as long as most of the information posting sites have a communication environment connectable to the internet, a user can access the information posting site from anywhere at any time and freely download and use a special gift such as a discount coupon posted on the information posting site. Therefore, a user who has already entered a store to be used can access the information posting site from inside the store to browse the store information and download and use the posted discount coupon or the like, and there are quite a few cases where the user does not use the discount coupon or the like in a form suitable for the purpose of marketing using the internet, which is originally assumed by the store or business operator. Therefore, there is a problem that the effect of attracting customers by providing a special gift such as a discount coupon is not sufficiently reflected in the information site in which the usage form different from the original assumption is not limited.

Under such circumstances, Patent Literature 1 discloses, for example, an apparatus where a lottery is drawn on a website and an electronic coupon is displayed to stimulate a user's temptation and promote the use of discount coupon.

However, Patent Literature 1 is not intended to motivate people to actually purchase services and commodities by means of information and a special gift posted on the information posting site, but merely increases the frequency of issuance and granting of a discount coupon or the number of accesses to a site for the purpose of playing a game by a game called a lottery. Therefore, it still does not lead to the effect of attracting customers for stores and business operators.

In order to lead the posting of store information on an information posting site on the internet and the provision of a special gift such as a discount coupon by a store or a business operator to an actual effect of attracting customers, it is important to associate a browsing history or the like as an evidence that a user has browsed the information posting site with a special gift that can be acquired or made available by actually visiting the store.

### CITATION LIST

### Patent Literature

Patent Literature 1: JP 2018-63547 A

### SUMMARY OF INVENTION

### Technical Problem

An object of the present invention is to provide a special gift granting system capable of granting a special gift to a user on the basis of a history of browsing store information by the user.

### Solution to Problem

According to the invention, the above objects are achieved by providing the following:
[1] A special gift granting system for granting a special gift to a user, the special gift granting system comprising a user terminal carried by a user; and a server apparatus capable of communication connection with a user terminal, wherein the user terminal includes a browsing request transmitter that transmits a store information browsing request and user identification information that can identify the user or the user terminal to the server apparatus; a store information receiver that receives store information from the server apparatus; a special gift request information acquirer that acquires a special gift request information for receiving a special gift at a store; and a special gift request information transmitter that transmits the acquired special gift request information and the user identification information to the server apparatus, and the server apparatus includes a browsing request receiver that receives the browsing request and the user identification information from the user terminal; a store information transmitter that transmits the store information to the user terminal; a history information storage that stores a history related to receiving the browsing request from the user terminal or transmitting the store information to the user terminal in association with the user identification information corresponding to the user terminal; a special gift request information receiver that receives the special gift request information and the user identification information from the user terminal; a history determiner that determines whether the history corresponding to the received user identification information is stored in the history information storage; and a first special gift granting enabler that enables granting of the special gift to the user when the history determiner determines that the history corresponding to the received user identification information is stored;
[2] The special gift granting system according to the [1], wherein the user terminal further includes a locator that locates the user terminal; and a position information transmitter that transmits position information related to a located position when the browsing request transmitter transmits the store information browsing request, the server apparatus further includes a position information receiver that receives the position information from the user terminal; and a position determiner that determines whether the position information received by the position information receiver is outside a predetermined range with respect to the position information of the store or the position information related to the located position at a time when the special gift request information is transmitted by the special gift request information transmitter, wherein the first special gift granting enabler enables granting of the special gift to the user when the position determiner determines that the position information is outside the predetermined range and the history determiner determines that the history corresponding to the received user identification information is stored;
[3] The special gift granting system according to the [1] or [2], wherein the history information storage stores a time at which the browsing request is received from the user terminal or a time at which the store information is transmitted to the user terminal, the special gift granting system further comprising a time determiner that determines whether an elapsed time from a time at which the browsing request is received from the user terminal or a time at which the store information is transmitted to the user terminal to a time at which the special gift request information is received from the user terminal is within a predetermined time, and the first special gift granting enabler enables granting of the special gift to the user when the time determiner determines that the elapsed time is within the predetermined range and the history determiner determines that the history corresponding to the received user identification information is stored;
[4] The special gift granting system according to any one of the [1] to [3], wherein the server apparatus further includes a special gift drawer that draws one or more special gifts from among a plurality of different special gifts, and the first special gift granting enabler enables the special gift selected through drawing to be granted to the user terminal;
[5] A special gift granting system for granting a special gift to a user, the special gift granting system comprising at least one computer device, wherein the computer device includes a first browsing information acquirer that acquires a browsing information including a browsing time at which the user browses a store information; and a browsing information displayer that displays the acquired browsing information, and a condition for granting a special gift to the user is that the browsing time satisfies a predetermined condition;
[6] The special gift granting system according to the [5], wherein the browsing information is a one-dimensional code or a two-dimensional code;
[7] The special gift granting system according to the [5] or [6], wherein the computer device is a user terminal owned by the user, the special gift granting system further comprising a store terminal used in a store, the store terminal includes a second browsing information acquirer that acquires the browsing information from the user terminal, and the special gift granting system further comprising a condition determiner that determines whether the browsing time included in the browsing information satisfies the predetermined condition for granting the special gift to the user;
[8] A special gift granting system for granting a special gift to a user, the special gift granting system comprising at least a user terminal owned by the user, wherein the user terminal includes a store information displayer that displays a store information, the special gift granting system further comprising a locator that locates the user terminal; a condition determiner that determines whether a predetermined condition for granting a special gift to the user is satisfied; and a second special gift granting enabler that enables granting of the special gift to the user terminal when it is determined that the predetermined condition is satisfied and a located position has a predetermined relation with a position of a store corresponding to the displayed store information, and the predetermined condition is that the user terminal displays the store information;
[9] The special gift granting system according to the [8], further comprising a granting information notifier that notifies the user terminal that the special gift can be granted when granting of the special gift to the user terminal is enabled by the second special gift granting enabler;
[10] A special gift granting system comprising a user terminal owned by a user; a store terminal used in a store; and a server apparatus capable of communication connection with the user terminal and the store terminal, wherein the user terminal includes a store information displayer that displays store information; a browsing information acquirer that acquires browsing information related to browsing of the store information by the user; and a browsing information displayer that displays the acquired browsing information, the store terminal includes a browsing information reader that reads the browsing information displayed on the user terminal; and a browsing information transmitter that transmits the read browsing information to the server apparatus, and the server apparatus includes a browsing information receiver that receives the browsing information from the store terminal; and a condition determiner that determines whether a predetermined condition for granting a special gift to the user is satisfied based on the received browsing information;
[11] The special gift granting system according to the [10], wherein the user terminal further includes a store information receiver that receives the store information from another server apparatus, the browsing information acquirer acquires the browsing information from the another server apparatus, the server apparatus includes a browsing history information receiver that receives browsing history information related to browsing of the store information by the user from the another server apparatus, and the condition determiner determines whether the predetermined condition for granting the special gift to the user is satisfied based on the received browsing information and the browsing history information;
[12] A special gift granting apparatus capable of communication connection with a user terminal carried by a user, the special gift granting apparatus comprising: a browsing request receiver that receives a store information browsing request and user identification information, which can identify the user or the user terminal, from the user terminal; a store information transmitter that transmits the store information to the user terminal; a history information storage that stores a history related to receiving the browsing request from the user terminal or transmitting the store information to the user terminal in association with the user identification information corresponding to the user terminal; a special gift request information receiver that receives a special gift request information for receiving a special gift at a store and the user identification information from the user terminal; a history determiner that determines whether the history corresponding to the received user identification information is stored in the history information storage; and a first special gift granting enabler that enables granting of the special gift to the user when the history determiner determines that the history corresponding to the received user identification information is stored;
[13] A special gift granting method executed in a special gift granting system that includes a user terminal carried by a user and a server apparatus capable of communication connection with the user terminal and grants a special gift to the user, wherein: the user terminal comprising a browsing request transmitting step of transmitting a store information browsing request and user identification information that can identify the user or the user terminal to the server apparatus; a store information receiving step of receiving store information from the server apparatus; a special gift request information acquiring step of acquiring a special gift request information for receiving a special gift at a store; and a special gift request information transmitting step of transmitting the acquired special gift request information and the user identification information to the server apparatus, and the server apparatus comprising a browsing request receiving step of receiving the browsing request and the user identification information from the user terminal; a store information transmitting step of transmitting the store information to the user terminal; a history information storing step of storing a history related to receiving the browsing request from the user terminal or transmitting the store information to the user terminal in association with the user identification information corresponding to the user terminal; a special gift request information receiving step of receiving the special gift request information and the user identification information from the user terminal; a history determining step of determining whether the history corresponding to the received user identification information is stored in the history information storing step; and a special gift granting enabling step of enabling granting of the special gift to the user when the history determining step determines that the history corresponding to the received user identification information is stored;
[14] A special gift granting method executed in a special gift granting system that includes at least one computer device and is for granting a special gift to a user, wherein: the computer device comprising a first browsing information acquiring step of acquiring browsing information including a browsing time at which the user browses store information; and a browsing information displaying step of displaying the acquired browsing information, wherein a condition for granting a special gift to the user is that the browsing time satisfies a predetermined condition;
[15] A special gift granting method executed in a special gift granting system that includes at least a user terminal owned by a user and is for granting a special gift to the user, wherein: the user terminal comprising a store information displaying step of displaying store information, and the special gift granting method comprising a locating step of locating the user terminal; a condition determining step of determining whether a predetermined condition for granting a special gift to the user is satisfied; and a second special gift granting enabling step of enabling granting of the special gift to the user terminal when it is determined that the predetermined condition is satisfied and a located position has a predetermined relation with a position of a store corresponding to the displayed store information, wherein the predetermined condition is that the user terminal displays the store information;
[16] A special gift granting method executed in a special gift granting system that includes a user terminal owned by a user; a store terminal used in a store; and a server apparatus capable of communication connection with the user terminal and the store terminal, wherein: the user terminal comprising a store information displaying step of displaying store information; a browsing information acquiring step of acquiring browsing information related to browsing of the store information by the user; and a browsing information displaying step of displaying the acquired browsing information, the store terminal comprising a browsing information reading step of reading the browsing information displayed on the user terminal; and a browsing information transmitting step of transmitting the read browsing information to the server apparatus, and the server apparatus comprising a browsing information receiving step of receiving the browsing information from the store terminal; and a condition determining step of determining whether a predetermined condition for granting a special gift to the user is satisfied based on the received browsing information;
[17] A special gift granting program executed on a user terminal in a special gift granting system that includes at least the user terminal owned by a user and is for granting a special gift to the user, wherein the special gift granting program causes the user terminal to function as a store information displayer that displays a store information; a locator that locates the user terminal; a condition determiner that determines whether a predetermined condition for granting a special gift to the user is satisfied; and a second special gift granting enabler that enables granting of the special gift to the user terminal when it is determined that the predetermined condition is satisfied and a located position has a predetermined relation with a position of a store corresponding to the displayed store information, wherein the predetermined condition is that the user terminal displays the store information.

### Advantageous Effects of Invention

According to the present invention, it is possible to provide a special gift granting system capable of granting a special gift to a user on the basis of a history of browsing store information by the user.

### BRIEF DESCRIPTION OF DRAWINGS

FIG. 1 is a block diagram illustrating a configuration of a user terminal according to an embodiment of the present invention.

FIG. 2 is a block diagram illustrating a configuration of a server apparatus according to an embodiment of the present invention.

FIG. 3 is an example of a diagram illustrating an outline of a special gift granting system according to an embodiment of the present invention.

FIG. 4 is a diagram showing flowchart of a special gift granting execution processing of the special gift granting system according to an embodiment of the present invention.

FIG. 5 is a diagram showing flowchart of a special gift granting execution processing of the special gift granting system according to an embodiment of the present invention.

FIG. 6 is a diagram illustrating an example of the history information database according to an embodiment of the present invention.

FIG. 7 is a diagram showing flowchart of a special gift granting execution processing in the special gift granting system according to an embodiment of the present invention.

FIG. 8 is a diagram showing flowchart of a special gift granting execution processing in the special gift granting system according to an embodiment of the present invention.

FIG. 9 is a diagram illustrating a flowchart of an execution processing of notifying a user terminal of special gift granting in the special gift granting system according to an embodiment of the present invention.

### DESCRIPTION OF EMBODIMENTS

Hereinafter, embodiments of the invention will be described with reference to the drawings. Hereinafter, description relating to effects of embodiments shows an aspect of the effects of the embodiments of the invention and does not limit the effects. Further, the order of respective processes that form a flowchart described below may be changed in a range without contradicting or creating discord with the processing contents thereof.

### First Embodiment

A special gift granting system of the present invention includes a user terminal carried by a user, and a server apparatus capable of communication connection with the user terminal.

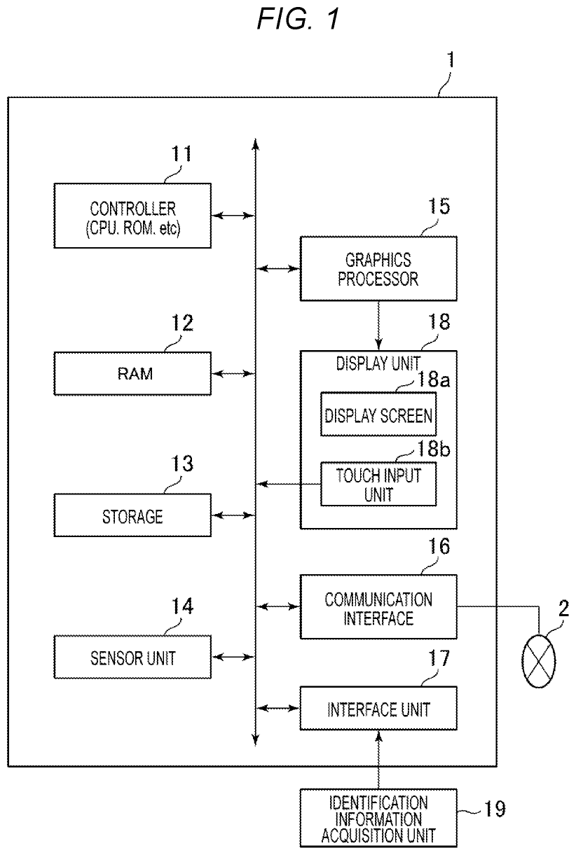

FIG. 1 is a block diagram illustrating a configuration of a user terminal according to an embodiment of the present invention. A user terminal 1 includes a controller 11, a RAM12, a storage 13, a sensor unit 14, a graphics processor 15, a display unit 18, a communication interface 16, and an interface unit 17, which are connected to each other via an internal bus.

The controller 11 includes a CPU and a ROM. The controller 11 executes a program stored in the storage 13 to control the user terminal 1. The RAM12 is a work area of the controller 11. The storage 13 is a storage area for storing programs and data.

The controller 11 reads programs and data from the RAM12 and performs processing. The controller 11 processes the programs and data loaded in the RAM12 to output a drawing command to the graphics processor 15.

The sensor unit 14 includes a GPS sensor. In addition, other various sensors may be included, and examples of the various sensors include a fingerprint authentication sensor, a proximity sensor, etc.

The graphics processor 15 is connected to the display unit 18. The display unit 18 has a display screen 18a. When the controller 11 outputs the drawing command to the graphics processor 15, the graphics processor 15 outputs a video signal for displaying an image on the display screen 18a. Here, the display unit 18 may be a screen of a touch panel including a touch input unit 18b.

The communication interface 16 can be connected to a communication network 2 in a wireless or wired manner, and can transmit and receive data to and from a server apparatus 3 via the communication network 2. The data received via the communication interface 16 is loaded into the RAM12 and arithmetically processed by the controller 11 in the same manner as the data read from an external memory.

An apparatus (for example, a camera, an OCR, a two-dimensional code reader that reads a barcode or a QR code (registered trademark), etc.) that enables acquisition of a code, character information, or an image related to identification information or the like can be connected to the interface unit 17 as an identification information acquisition unit 19. The information acquired by the user from the identification information acquisition unit 19 is stored in the RAM12, and the controller 11 executes various types of arithmetic processing based on the acquired information. Alternatively, a storage medium reading device may be connected to the interface unit 17 to read programs, data, and the like from an external memory or the like.

The user terminal 1 is not particularly limited, but it is preferable that the user can carry the user terminal 1 around. Examples of the user terminal 1 include a conventional mobile phone, a tablet terminal, a smartphone, etc.

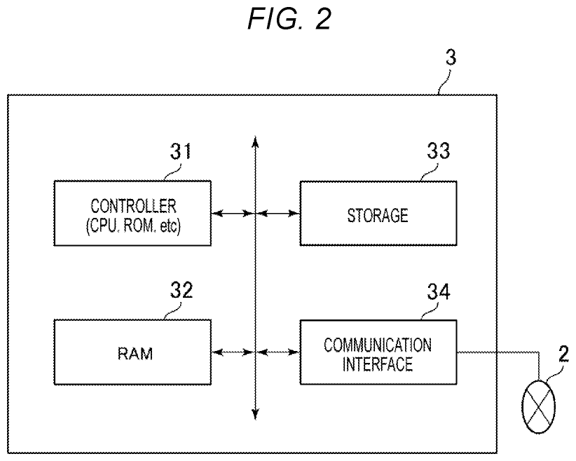

FIG. 2 is a block diagram illustrating a configuration of a server apparatus according to an embodiment of the present invention. The server apparatus 3 includes at least a controller 31, a RAM 32, a storage 33, and a communication interface 34, which are connected to each other via an internal bus.

The controller 31 includes a CPU and a ROM, and executes a program stored in the storage 33 to control the server apparatus 3. The controller 31 includes an internal timer for measuring time. The RAM 32 is a work area of the controller 31. The storage 33 is a storage area for storing programs and data. The controller 31 reads programs and data from the RAM 32, and performs a program execution processing based on information and the like received from the user terminal 1.

The communication interface 34 can be connected to the communication network 2 in a wireless or wired manner, and can transmit and receive data via the communication network 2. The data received via the communication interface 32, for example, is loaded into the RAM 32 and arithmetically processed by the controller 31.

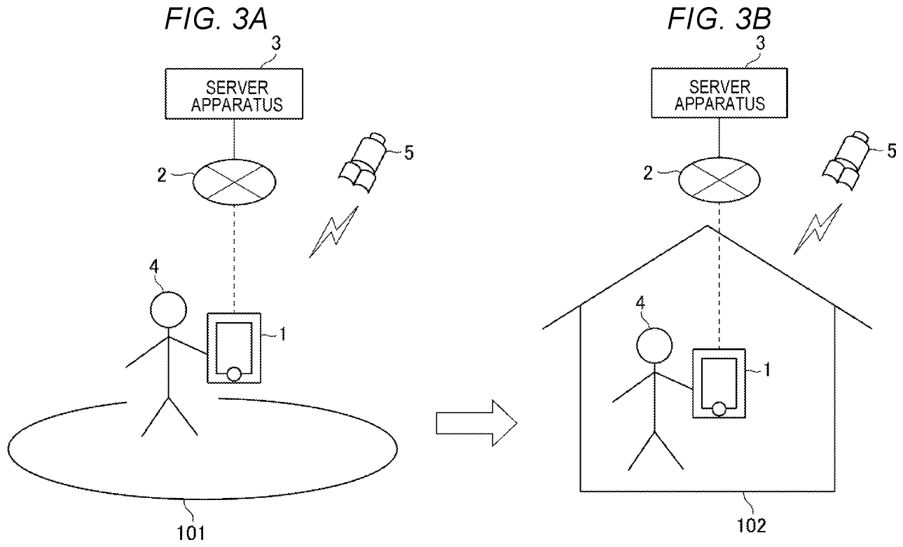

An outline of the special gift granting system of the present invention will be described with reference to FIG. 3. FIG. 3 is an example of a diagram illustrating an outline of a special gift granting system according to an embodiment of the present invention. Hereinafter, a case will be described in which a user browses store information of a website in an area shown in FIG. 3A which is a place outside a store, then moves to a place shown in FIG. 3B which is the actual store, and transmits a special gift granting request from a user terminal to a server apparatus.

In FIG. 3, an out-of-store area 101 shown in FIG. 3A is the user location at the time when a user 4 of the store browses the store information with the user terminal 1, and the user 4 accesses the website on the server apparatus 3 where the store information is posted using the user terminal 1 carried by the user 4 in the out-of-store area 101 to browse the store information. The out-of-store area 101 is not particularly limited as long as it is an out-of-store place located outside a predetermined range from the store and the user terminal 1 can communicate with the server apparatus 3 via the communication network 2 there, and may be an outdoor place, an indoor place, an underground passage, an underground commercial facility, or the like.

A store 102 illustrated in FIG. 3B is a destination to which the user 4 of the store moves after browsing the store information of the website on the server apparatus 3, and is a place different from the out-of-store area 101 located outside the predetermined range from the position of the store 102. Since the user terminal 1 is always carried by the user 4 during the movement of the user 4 from the out-of-store area 101 to the store 102, when the user 4 moves from the out-of-store area 101 to the store 102, the position of the user terminal 1 also moves from the out-of-store area 101 to the inside of the store 102.

The user terminal 1 is a terminal device that transmits and receives various kinds of information to and from the server apparatus 3 by an operation of the user 4 for the user 4 to browse store information posted on a website on the server apparatus 3 or transmit a special gift request information for receiving a special gift provided in the store 102 to the server apparatus 3. The user terminal 1 has a browsing request transmission function for transmitting a store information browsing request and user identification information, which can identify a user or the user terminal 1, to a server apparatus. Examples of the user identification information include a MAC address as terminal identification information, and a user ID in a case where a user is registered in advance as a user of a service using the special gift granting system, etc. The user terminal 1 has a store information receiving function of receiving store information from the server apparatus 3. The store information may include, for example, information on services and commodities sold by the corresponding store, a special gift information such as discount coupon information that can be used when a service or a commodity is purchased at the store, and information such as business hours and an address of the store. The user terminal 1 has a special gift request information acquisition function of acquiring a special gift request information for receiving a special gift provided in the store 102, and a special gift request information transmission function of transmitting the acquired special gift request information and user identification information to the server apparatus 3. Examples of the special gift request information include a QR code (registered trademark) of each store provided in a store that grants a special gift such as a coupon to the user 4 by using the special gift granting system, and a barcode of each service or each commodity provided for the services and commodities provided by the store, etc.

The user terminal 1 is not particularly limited as long as the user terminal 1 can be carried and moved by the user 4, and examples of the user terminal 1 include a conventional mobile phone, a tablet terminal, a smartphone, etc. In the user terminal 1, a known web browser or a dedicated application may be installed in advance so that a web site provided on the server apparatus 3 can be browsed and the special gift request information can be transmitted to the server apparatus 3.

The user terminal 1 has a locating function of locating the position of the user terminal. For example, the user terminal 1 includes a GPS sensor and measures the position of the user terminal 1 based on a signal from a GPS satellite 5. The locating function is not limited to a function using a GPS sensor and may be any function as long as the position of the user terminal 1 can be located, for example, the position can also be located based on a reception state of Wi-Fi radio waves.

In addition, the user terminal 1 may be configured to have a position information transmission function of transmitting position information related to the located position of the user terminal 1 to the server apparatus 3 at a time when the store information browsing request is transmitted to the server apparatus 3 by the browsing request transmission function. Specifically, for example, the server apparatus 3 records information of a position located by the GPS sensor of the user terminal 1 at the time of browsing the store information on the website, then the special gift request information acquisition function (for example, a camera provided in the user terminal 1 or a two-dimensional code reader capable of reading the QR code (registered trademark) or the like) acquires the QR code (registered trademark) or the like provided in the store 102 as the special gift request information for the user 4 to receive the special gift from the store 102, and the server apparatus 3 reads the position information of the store 102 registered in advance in the server apparatus 3 from a database or the like when the acquired special gift request information is transmitted to the server apparatus 3 by the special gift request information transmission function, and compares the position information of the out-of-store area 101 with the position information of the store 102 in the server apparatus 3, thereby identifying that the user 4 has moved from the out-of-store area 101 to the store 102 in the server apparatus 3.

The server apparatus 3 receives the browsing request and the user identification information transmitted from the user terminal 1, and transmits the store information to the user terminal 1.

The server apparatus 3 has a browsing request receiving function for receiving a browsing request and a user identification information from the user terminal 1, a store information transmission function for transmitting store information to the user terminal 1, and a history information database for storing a history related to reception of a browsing request from the user terminal 1 or transmission of store information to the user terminal 1 in association with the user identification information corresponding to the user terminal 1. At this time, the position information related to the position of the user terminal 1 located by the locating function of the user terminal 1 when the browsing request is received may be received from the user terminal 1 and stored in association with the history. In addition, the time when the browsing request is received from the user terminal 1 or the time when the store information is transmitted to the user terminal 1 may be stored in association with the history.

Further, the server apparatus 3 has a special gift request information receiving function of receiving the special gift request information and the user identification information from the user terminal 1, and a history determining function of determining whether or not the history corresponding to the received user identification information is stored in the history information database to be described later. Further, the server apparatus 3 has a special gift granting enabling function for enabling granting of a special gift to the user when it is determined by the history determining function that the history corresponding to the received user identification information is stored in the history information database.

The server apparatus 3 may be configured to have a position information receiving function of receiving position information from the user terminal 1 and a position determining function of determining whether or not the position information received by the position information receiving function when receiving a browsing request from the user terminal 1 is out of a predetermined range with respect to the position information of the store or the position information related to the position located by the locating function of the user terminal 1 when receiving the special gift request information transmitted by the special gift request information transmission function of the user terminal 1. Preferably, at this time, when it is determined by the position determining function that the out-of-store area 101 to which the user terminal 1 has transmitted the browsing request is outside the predetermined range from the store 102 and it is determined by the history determining function that the history corresponding to the received user identification information is stored in the history information database, the special gift granting enabling function enables granting of a special gift to the user 4 of the store. With such a configuration, it is possible to prevent a user who has already entered the store to be used before browsing the store information of the store from accessing the information posting site from inside the store to browse the store information and to download and use the posted discount coupon or the like, and thus, special gifts such as discount coupons can be granted to users of the store in accordance with the purpose of marketing using the internet, and can be reflected in attracting customers.

In addition, the server apparatus 3 may be configured to be able to store the time when the browsing request is received from the user terminal or the time when the store information is transmitted to the user terminal as the history in the history information database. Preferably, in this case, the special gift granting system includes a time determining function of determining whether or not the elapsed time from the time when the browsing request is received from the user terminal 1 or the time when the store information is transmitted to the user terminal 1 to the time when the special gift request information is received from the user terminal 1 is within a predetermined time, wherein the server apparatus 3, regarding the special gift granting enabling function, is able to grant a special gift to the user when the time determining function determines that the elapsed time is within the predetermined range and the history determining function of the server apparatus 3 determines that the history corresponding to the received user identification information is stored in the history information database. With such a configuration, the elapsed time from when the user browses the store information outside the store to when the user moves to the corresponding store and acquires the special gift request information by the user terminal 1 at the store can be added to the condition for enabling the special gift to be granted to the user, and thus, it is possible to prove with higher accuracy that the user has browsed the store information in advance. Therefore, it is possible to more accurately reflect the marketing effect due to granting of a special gift on the special gift granting system.

In the special gift granting system according to the present invention, the business entity that operates the server apparatus and the store or business operator that has registered the store information in the server apparatus cooperate with each other, so that it is possible to obtain a synergistic effect in the customer attracting effect by the improvement of the utilization rate of the special gift granting system and the stimulation of the user's buying intention due to the special gift granting. Therefore, for example, by introducing an environment in which the server apparatus of the special gift granting system can be accessed through the web into an accommodation facility or the like of a sightseeing spot, and making it possible to browse store information of a souvenir shop or a restaurant, etc. around the accommodation facility or information relating to services and commodities, the special gift granting system can be used for regional activation, attraction of tourists, etc.

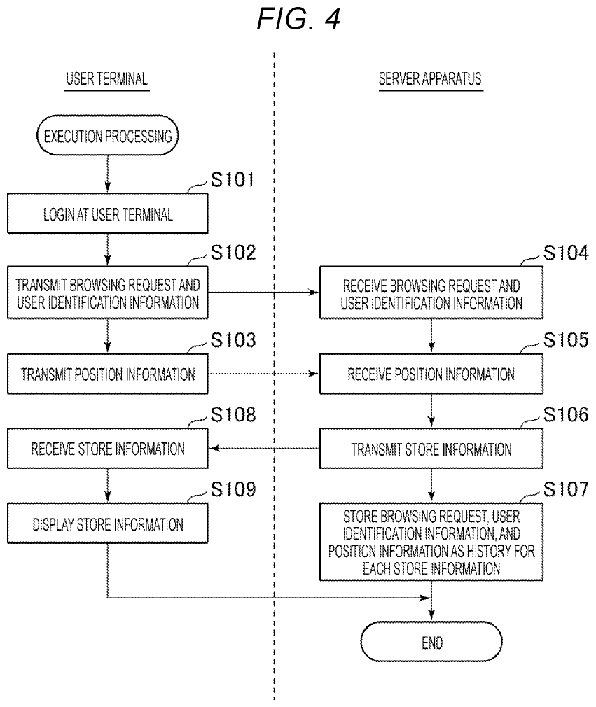

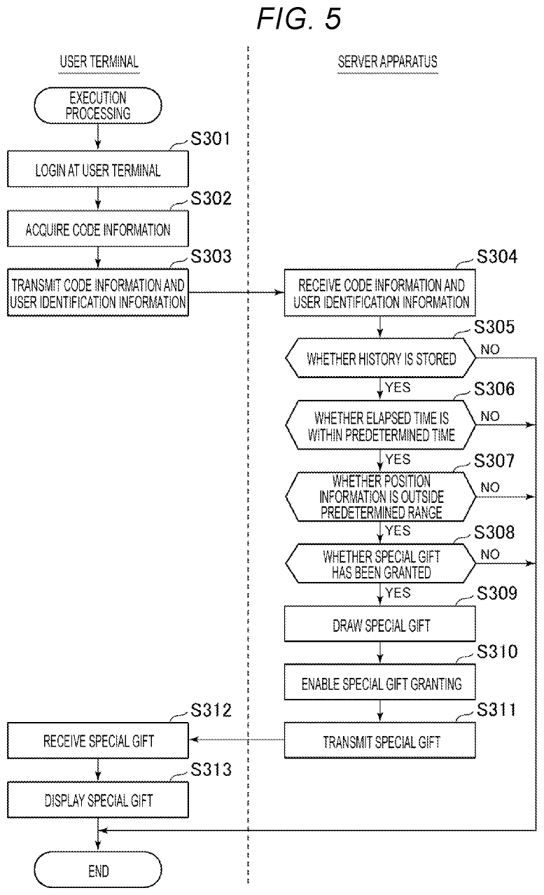

Next, a special gift granting execution processing in the special gift granting system according to the present embodiment will be described. FIG. 4 and FIG. 5 are diagrams showing flowcharts of a special gift granting execution processing of the special gift granting system according to an embodiment of the present invention.

First, with reference to FIG. 4, a description will be given of a flow of execution processing for receiving a store information browsing request from a user terminal and storing a history related to reception of the browsing request or transmission of the store information to the user terminal in association with the user identification information corresponding to the user terminal in a server apparatus. The user of the store operates the user terminal 1 and logs in to the special gift granting system by using the user identification information which can identify the user or the user terminal 1 (step S101).

Next, in response to an operation by the user, the user terminal 1 transmits a store information browsing request and the user identification information which can identify the user or the user terminal 1 to the server apparatus 3 (step S102). In addition, the user terminal 1 transmits the position information related to the position of the user terminal 1 located by the locating function such as GPS to the server apparatus 3 (step S103).

The server apparatus 3 receives the browsing request and the user identification information from the user terminal 1 (step S104). In addition, the server apparatus 3 receives, from the user terminal 1, the store information browsing request and the position information related to the position of the user terminal 1 at the time of receiving the user identification information (step S105).

Next, the server apparatus 3 transmits the store information to the user terminal 1 based on the received browsing request (step S106). Here, the store information transmitted to the user terminal 1 is registered in advance in the server apparatus 3, and is transmitted from the server apparatus 3 to the user terminal 1 in a browsable manner in response to a browsing request from the user terminal 1. In step S106, the store information may include a special gift information related to a special gift such as a coupon set for each store, each service, or each commodity (more specifically, for example, information such as a discount rate for each commodity when a coupon is used), but does not include the special gift itself usable for each store, each service, or each commodity (more specifically, for example, a discount coupon or the like usable at the time of purchasing a commodity or the like).

Next, the server apparatus 3 stores the history related to the reception of the browsing request from the user terminal 1 or the transmission of the store information to the user terminal 1 in the history information database to be described later in association with the user identification information corresponding to the user terminal 1 for each store information, or each service and each commodity (step S107). In step S107, it is preferable that the server apparatus 3 also receives the position information related to the position of the user terminal 1 at the time of receiving the store information browsing request from the user terminal 1 and the user identification information transmitted together with the browsing request, and stores the position information in the history information database in association with the history and the user identification information and with each store information, or each service and each commodity. Further, in step S107, it is preferable that the time when the server apparatus 3 receives the browsing request from the user terminal 1 or the time when the server apparatus 3 transmits the store information to the user terminal 1 is stored in the history information database in association with the history and the user identification information and with each store information, or each service and each commodity.

Upon receiving the store information from the server apparatus 3 (step S108), the user terminal 1 displays the received store information on the display screen 18a of the user terminal 1 in a browsable manner (step S109), and ends the execution processing.

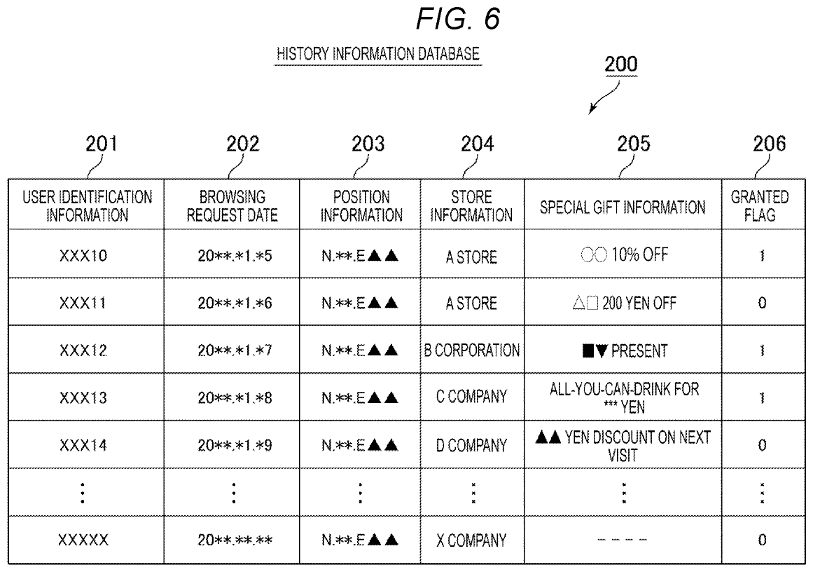

Here, the history information database according to the present embodiment will be described. FIG. 6 is a diagram illustrating an example of the history information database according to an embodiment of the present invention. In a history information database 200, a browsing request date 202, a position information 203, a store information 204, a special gift information 205, a special gift granted flag 206, and the like are stored in association with a user identification information 201. The browsing request date 202 represents the system date in the server apparatus 3 at the time when the history is stored or updated in step S107 of the execution processing shown in FIG. 4, and the position information 203 represents the coordinates of the located position in step S107. The store information 204 and the special gift information 205 represent the store information and the special gift information related to the store, which are browsed by the user terminal that has made a browsing request or transmitted by the server apparatus to the user terminal based on the browsing request. The issued flag 206 indicates whether or not a coupon has already been issued, and becomes ON (1) when a special gift has already been granted to the user terminal, and becomes OFF (0) when a special gift has not yet been issued.

Here, the special gift granting execution processing in the special gift granting system according to the present embodiment will be described again. Hereinafter, with reference to FIG. 5, a description will be given of the flow of execution processing, in which the user terminal acquires a special gift request information provided in a store by using the special gift request information acquisition function included in the user terminal and transmits the special gift request information to the server apparatus by an operation of the user, so that a special gift can be granted to the user in the server apparatus. Hereinafter, a case will be described as an example in which a code information using a two-dimensional code is provided for each store as the special gift request information for receiving the special gift provided in each store. In addition, it is assumed that the time when the server apparatus 3 receives the browsing request from the user terminal 1 is stored as the time stored in the history information database.

In the flow of the execution processing shown in FIG. 4, the user who has browsed the store information using the user terminal 1 in an out-of-store area located outside the predetermined range from the store subsequently moves from the out-of-store area and visits the store corresponding to the browsed store information. The user who visits the store corresponding to the store information logs in to the special gift granting system using the user identification information (step S301), and acquires the code information for receiving the special gift related to the browsed store information, which is provided in advance in the store, by the special gift request information acquisition function of the user terminal 1 (step S302). Next, the user terminal 1 transmits the acquired code information and user identification information to the server apparatus 3 (step S303).

Upon receiving the code information and the user identification information from the user terminal 1 (step S304), the server apparatus 3 determines whether or not the history corresponding to the received user identification information is stored in the history information database (step S305). In step S305, when the corresponding history is not stored in the history information database (No in step S305), the server apparatus 3 ends the execution processing without granting a special gift to the user terminal 1. In step S305, when the history corresponding to the user identification information received in step S304 is stored in the history information database (Yes in step S305), the server apparatus 3 subsequently determines for the history whether or not the elapsed time from the time when the browsing request is received from the user terminal 1 to the time when the code information is received from the user terminal 1 is within a predetermined time (step S306). The predetermined time is, for example, preferably 5 minutes or more, and more preferably 10 minutes or more. The predetermined time is preferably 48 hours or less, and more preferably 24 hours or less. With such a configuration, it is possible to more accurately grasp, from the viewpoint of the elapsed time, that the reason why the user has visited the store is motivated by browsing the store information related to the store.

In step S306, when it is determined that the elapsed time is shorter or longer than the predetermined time (No in step S306), the execution processing is ended without granting a special gift. When it is determined in step S306 that the elapsed time is within the predetermined time (Yes in step S306), the process proceeds to the next determining step.

When it is determined in step S306 that the elapsed time is within the predetermined time, that is, when the history corresponding to the user identification information of the user terminal 1 that has transmitted the code information is stored in the history information database and the elapsed time is within the predetermined time, the server apparatus 3, with respect to the store corresponding to the code information received from the user terminal 1, compares the position information of the store registered in advance with the position information received from the user terminal 1 in step S105 of FIG. 4 at the time of making the store information browsing request related to the store. Then, it is determined whether or not the position information received in step S105 is out of a predetermined range with respect to the position information of the store (step S307). As the outside of the predetermined range, the position information received in step S105 is preferably 20 m or more, more preferably 100 m or more, away from the position information of the store. With such a configuration, even when a locating function such as GPS with insufficient locating accuracy is used, it is possible to exclude a case where a user who does not browse store information before visiting a store obtains a special gift by transmitting the code information of the store inside the store or in the vicinity of the store using the position information, and thus more accurately grasp the customer attracting effect due to special gift granting.

In step S307, when it is determined that the position information at the time of making the store information browsing request is not outside the predetermined range with respect to the position information of the store (No in step S307), the server apparatus 3 ends the execution processing without granting a special gift.

When it is determined in step S307 that the position information is outside the predetermined range (Yes in step S307), the server apparatus 3 refers to the special gift granted flag in the history corresponding to the user identification information of the user terminal 1 regarding the user terminal 1 corresponding to the relevant history, and determines whether or not the special gift corresponding to the received code information has been granted to the user terminal 1 from the server apparatus 3 (step S308). When the special gift of each store or each browsing history corresponding to the code information has already been granted to the user terminal 1 (Yes in step S308), the server apparatus 3 ends the execution processing without granting any more special gift to the user terminal 1.

When it is determined that no special gift has been granted to the user terminal 1 (No in step S308), the server apparatus 3 draws one or more special gifts from among a plurality of different special gifts in order to identify the special gift of each store or each browsing history granted to the user terminal 1 (step S309). Then, the special gift of each store or each browsing history selected through drawing can be granted to the user terminal 1 (step S310).

When the special gift is identified to be grantable in step S310, the server apparatus 3 transmits the special gift identified to be grantable to the user terminal 1 (step S311). The user terminal 1 receives the special gift from the server apparatus 3 (step S312), and displays the special gift on the display screen 18a (step S313).

In the present embodiment, the form of granting a special gift and the number of special gifts to be granted are not particularly limited, and a different special gift (for example, a coupon with a different discount rate, etc.) may be granted to the user terminal 1 for each store, for each browsing history of store information of the user terminal 1 recorded in the history information database, for each store information, or for each service and each product.

In the present embodiment, as the time stored in the history information database, the time when the server apparatus transmits the store information to the user terminal may be adopted instead of the time when the server apparatus receives the browsing request from the user terminal. Further, in the present embodiment, it may be determined whether or not the position information received by a position information receiving means is out of a predetermined range with respect to the position information related to the position located by the locating function of the user terminal at a time when the user terminal transmits the special gift request information to the server apparatus instead of the position information of the store.

In the present embodiment, the special gift request information for receiving a special gift provided in a store is not particularly limited, and a code, character information, an image, an identification tag, or the like related to conventionally known identification information or the like can be adopted.

### Second Embodiment

Next, an outline of a second embodiment of the present invention will be described. According to the special gift granting system of the second embodiment, it is possible to determine whether or not to grant a special gift to a user by comparing a browsing time when the user browses store information with a current time which is a time when the user enters a store corresponding to the store information or a time when the browsing information of the store information is displayed in the store and determining whether or not a predetermined condition is satisfied in terms of time.

The contents described in the first embodiment can be adopted within a necessary range as the description related to the determination of whether or not to grant a special gift in the second embodiment. For specific configurations of the user terminal and the server apparatus (including both a Web server and a management server to be described later), the contents related to the user terminal and the server apparatus described in the first embodiment can be adopted within a necessary range.

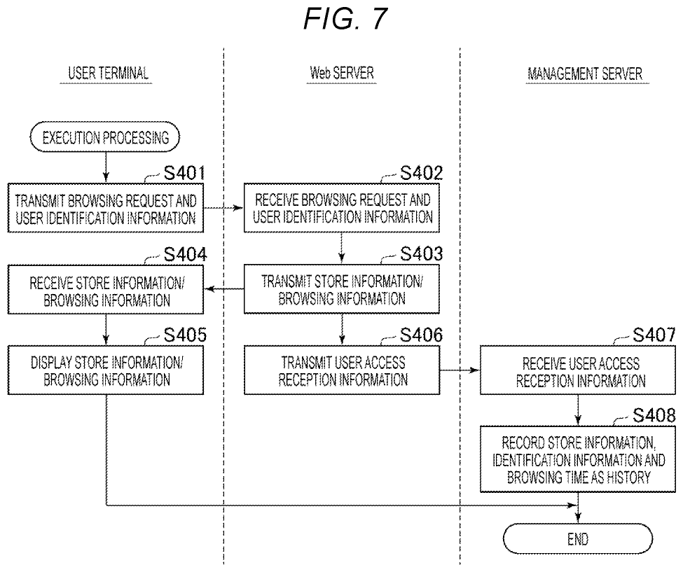

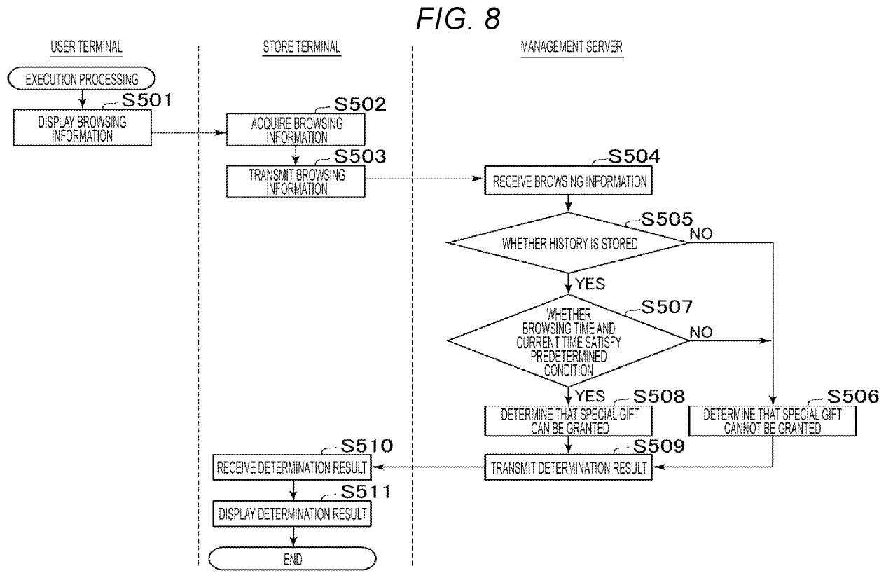

Hereinafter, a special gift granting execution processing in the special gift granting system according to the second embodiment will be described with reference to the drawings. FIG. 7 and FIG. 8 are diagrams showing flowcharts of a special gift granting execution processing in the special gift granting system according to the embodiment of an present invention.

Here, with reference to FIG. 7, a description will be given of a flow of execution processing in a case where, in the Web server, when a store information browsing request is received from a user terminal, store information of the store for which the browsing request is made from the user terminal and browsing information which is information regarding that a user has browsed the store information with the user terminal are transmitted to the user terminal.

First, a user operates a user terminal to access a Web site on a Web server where the store information desired to be browsed is posted. At the time of accessing the Web site, the user terminal transmits, to the Web server, a store information browsing request desired to be browsed and user identification information such as an IP address that can be used to identify the user terminal (step S401).

When the Web server receives a store information browsing request that the user desires to browse and user identification information such as an IP address from the user terminal (step S402), the Web server generates code information as the browsing information related to the user browsing the store information based on information like: the user identification information received from the user terminal; the browsing time indicating the time period or time when the user terminal accesses the store information on the Web server or when the user browses the store information on the Web server; and the identification information of the store corresponding to the store information for which the user terminal has accessed the browsing request, and then the Web server transmits the generated code information and store information corresponding to the user's browsing request to the user terminal (step S403).

In step S403, when the code information transmitted from the Web server to the user terminal is, for example, displayed on the display screen of the user terminal, the code information may be displayed side by side with the store information corresponding to the user's browsing request on the same screen, and for example, a button that can be clicked or tapped by the user through an operation input to generate code information may appear on a portion of the display screen when the store information is displayed, and the user may click or tap the button displayed on the display screen by an operation input to the user terminal to generate the code information related to the store information corresponding to the user's browsing request. The code information generated in this way or displayed on the display screen is not particularly limited, but the code information is preferably, for example, a one-dimensional code such as a barcode or a two-dimensional code such as a QR code (registered trademark).

When the user terminal receives the store information corresponding to the browsing request transmitted in step S401 or the browsing information including the browsing time during which the user terminal browses the store information from the Web server (step S404), the user terminal displays the received store information and/or browsing information on the display screen of the user terminal in a browsable manner (step S405). The display method of browsing information is not particularly limited, for example, the browsing information may be displayed on the display screen of the user terminal via a browser, or may be displayed by activating a dedicated application for using the present system.

The Web server that has transmitted the browsing information to the user terminal in step S403 then generates user access reception information indicating that access to or browsing of the store information has been requested from the user terminal, and transmits the user access reception information to the management server (step S406). The user access reception information transmitted to the management server in step 5406 includes, for example, the user identification information, the browsing time, the identification information of the store, and the like.

On the other hand, when the management server receives the user access reception information from the Web server (step S407), the management server stores the user identification information, the browsing time, the identification information of the store, and the like in the database as a browsing history of the store information by the user terminal based on the received user access reception information (step S408), and ends the execution processing.

In the second embodiment, the browsing information is information related to the user browsing the store information, but is not limited thereto. The browsing information may be, for example, anything that indicates that a user terminal has accessed the Web server, more specifically, for example, the browsing information is generated in response to the user terminal accessing the Web server, and the browsing information may be generated in response to the user terminal accessing the Web server or may be acquired due to the user terminal accessing the Web server even when the user does not actually browse the store information. In addition, the browsing information may include, for example, store information of a store that the user desires to browse, identification information of the store corresponding to the store information, the browsing time when the user browses the store information, and the like, and may be configured as code information including a one-dimensional code or a two-dimensional code.

In the second embodiment, the time when the user browses the store information has been described as an example of the browsing time, but the browsing time is not limited thereto. The browsing time may be, for example, a time at which the user browses the store information using the user terminal, or a length of a time period during which the user browses the store information. In addition, both of the time and the length of the time period may be included. The time of browsing may be, for example, a time at which browsing is started, a time at which browsing is ended, or a time between the start time and the end time. Furthermore, the browsing time may be, for example, a time when a user terminal accesses the Web server or Web site.

In the second embodiment, a Web server and/or a Web site has been described as an example of a medium on which store information browsed by a user is posted, but instead of the Web server and/or the Web site, another server apparatus different from the Web server of the present system, a Web site on the another server apparatus, or another Web advertisement different from the Web site on the another server apparatus may be used. As the another Web advertisement, for example, an internet advertisement posted on another Web site different from the Web site on the Web server of the present system, an article advertisement posted on an internet medium, or a digital signage on the street, etc. may be adopted as the another Web advertisement.

In addition, in the second embodiment, an advertisement other than Web advertisement may be used instead of the Web advertisement as a medium on which the store information browsed by the user is posted. More specifically, for example, a paper medium advertisement, a TV advertisement, a street advertisement, or the like may be appropriately adopted as the posting destination of the store information or the code information in the present system.

Further, in the second embodiment, the position information of the place or location where the Web advertisement is arranged is included in the store information and/or the code information posted in the Web advertisement and can be acquired by the user terminal, and thus, the position information can be used as the position information of the user and/or the user terminal when the user browses the store information posted in the Web advertisement. In such a configuration, the contents described in the first embodiment can be adopted within a necessary range as the position information at the time of browsing the store information.

Further, in the second embodiment, when the store information and/or the code information posted on the Web advertisement is acquired by the user terminal, the time when the store information and/or the code information is read by the user terminal, or the access time period or the access time when the URL displayed at the time of reading the store information and/or the code information is accessed by the user terminal may be adopted as the browsing time when the user browses the store information. In such a configuration, the browsing time may be identified by a clock timer included in the user terminal, or may be identified by a clock timer included in a Web server to be accessed when the user terminal accesses the URL, or another server apparatus to be accessed. The identified browsing time may be transmitted from the user terminal, the Web server, or another server apparatus to the management server and stored in the history information database as a browsing history. In such a configuration, as the browsing time of the store information, the contents described in the first embodiment and the second embodiment can be adopted within a necessary range.

In the second embodiment, when the Web advertisement uses a computer device, such as a digital signage, connectable to a communication network in a wired or wireless manner, the computer device may acquire user identification information from a user terminal, and the acquired user identification information may be transmitted to the management server together with position information on a position where the Web advertisement and/or the computer device is arranged, store information posted in the Web advertisement, or a browsing time when the user browses the store information posted in the Web advertisement. The Web advertisement and/or the computer device may be configured to simply acquire user identification information, position information, and browsing time from the user terminal without having means for identifying the position information of the arrangement location and without performing clocking by an internal timer, and may be configured to transmit the user identification information, position information, and browsing time acquired from the user terminal to the management server as they are together with the store information posted in the Web advertisement. In such a configuration, it is preferable that the management server stores the Web advertisement and/or the user identification information, the position information, and the browsing time received from the computer device, and the store information posted in the Web advertisement in the history information database as a browsing history. In such a configuration, the contents described in the first embodiment and the second embodiment may be adopted within a necessary range for the user identification information, the position information, the browsing time of the user terminal and the store information stored in the history information database as the browsing history.

Further, in the second embodiment, the user terminal can display or identify the URL associated with the store information posted on the Web advertisement on the display screen of the user terminal by reading code information such as a QR code (registered trademark), for example, but the method of identifying the URL associated with the store information posted on the Web advertisement is not limited thereto. Regarding the method of identifying the URL associated with the store information posted on the Web advertisement, for example, the Web advertisement may include a signal transmitting means that transmits a signal such as sound, radio wave, or light that can be acquired by the user terminal, wherein the URL may be identified by receiving the signals such as sound, radio wave, or light of a specific wavelength transmitted by the signal transmitting means on the user terminal.

Next, a description will be given of a specific outline of entry into a store corresponding to store information browsed by a user in the second embodiment of the present invention. In the second embodiment, it is possible to determine whether or not a special gift can be granted to a user by identifying that the user has entered a store corresponding to store information browsed by the user in advance at the store, and comparing a history of browsing of store information by the user with the fact that the user has entered the store identified at the store.

Hereinafter, with reference to FIG. 8, a description will be given of a flow of execution processing in a case where browsing information including a browsing time when store information is browsed from a user terminal is acquired by using a store terminal in a store and it is determined whether or not a special gift can be granted in the store or the management server according to the invention of the present system.

In step S405 of FIG. 7, the user terminal, which has received the browsed store information and/or the browsing information including the browsing time when the store information has been browsed, subsequently enters the store corresponding to the browsed store information. The user who has entered the store corresponding to the store information displays the browsing information received in step S405 of FIG. 7 on the display screen of the user terminal (step S501 of FIG. 8), and presents the browsing information in the store.

Next, the store or the staff of the store such as a clerk who receives the presentation of the browsing information from the user reads the browsing information from the user terminal using the store terminal of the store (step S502), and transmits the read browsing information to the management server (step S503).

The management server determines whether or not a special gift can be granted to the user based on the browsing information read by the store terminal. First, the management server receives the browsing information from the store terminal (step S504), and identifies whether or not the browsing history corresponding to the received browsing information is stored in the database of the management server (step S505).

When identifying the browsing history corresponding to the browsing information, in step S505, the management server identifies whether or not a browsing history having user identification information and store identification information matching the user identification information and store identification information included in the browsing information is stored from among a plurality of browsing histories including the browsing history stored in the database in step S408 of FIG. 7.

In step S505, when the browsing history corresponding to the browsing information is stored in the database (Yes in step S505), the management server then determines whether or not the user terminal satisfies the condition for granting a special gift. Here, when the browsing history corresponding to the browsing information is not stored in the database (No in step S505), the management server determines that the special gift cannot be granted to the user terminal in a stage before proceeding to the condition determination to be described later (step S506).

In the condition determination for determining whether or not the condition for granting the special gift is satisfied, the management server compares the time of the user terminal accessing to the Web server or the browsing time when the user browses the store information stored in the browsing history identified in step S505 with the current time to determine whether or not the predetermined condition is satisfied (step S507).

Here, as the current time in the second embodiment, for example, the time at which the user enters the store or the time at which the user orders a product or a service in the store can be appropriately adopted in accordance with the business situation of the store or the like. Further, as the current time in the second embodiment, for example, the time when the store terminal reads the browsing information from the user terminal may be adopted as the time of entering the store or the time of ordering a product or a service in the store. In addition, as the current time in the second embodiment, for example, a time measured by an internal timer or the like of the management server or the user terminal immediately before the management server performs the condition determination for granting a special gift to the user terminal may be adopted, or for example, a time when the management server receives browsing information on the user terminal from the store terminal may be adopted.

In addition, as the predetermined condition in step S507, for example, when the browsing time at which the user browses the store information is compared with the current time, a fact that the current time has passed a predetermined time from the browsing time can be adopted as the condition. Here, “has passed a predetermined time” may be, for example, a condition that the browsing time and the current time are simply shifted or different from each other. In addition, for example, when the browsing time and the current time are compared with each other, a fact that an elapsed time from the browsing time to the current time is within a predetermined time may be adopted as the condition. In this case, the predetermined time is not particularly limited, but the predetermined time is preferably 5 minutes or more, and more preferably 10 minutes or more, for example. The predetermined time is preferably 48 hours or less, and more preferably 24 hours or less. With such a configuration, it is possible to accurately grasp, quantitatively and/or qualitatively, that the reason why the user has entered the store corresponding to the store information is being motivated by browsing the store information related to the store on the Web site according to the special gift granting system of the present invention by comparing the browsing time with the current time.

In the second embodiment, with such a configuration, it is possible to measure, for example, the statistical tendency of the user who satisfies the special gift granting condition from the comparison between the browsing time and the current time, and this measurement can be utilized for the development of a more effective customer attracting method.

Returning to the flow of FIG. 8, when the relation between the browsing time and the current time satisfies the predetermined condition in step S507 (Yes in step S507), the management server determines that a special gift can be granted to the user terminal (step S508). When the relation between the browsing time and the current time does not satisfy the predetermined condition in step S507 (No in step S507), the management server determines that the special gift cannot be granted to the user terminal (step S506).

Next, the management server transmits the determination result in step S508 or step S506 to the store terminal (step S509).

Next, after receiving the determination result from the management server (step S510), the store terminal displays the received determination result (step S511) and ends the execution processing.

When the determination result received in step S510 is “special gift can be granted”, a special gift such as discount of charge or addition of service is granted to the user who has presented the browsing information in the store. Here, the method of granting a special gift is not particularly limited, and the processing of special gift granting may be automatically performed by a computer device such as a store terminal having an ordering function or a settlement function of a product or a service, or a staff of a store such as a clerk may visually confirm a determination result, manually input a charge to a cash register or the like at the time of accounting, and directly discount a settlement amount.

When the determination result received in step S510 is “no special gift can be granted”, it is determined that the user who presented the browsing information at the store does not satisfy the special gift granting condition, and the user cannot receive a special gift such as a discount of charge at the store.

In the second embodiment, the store terminal acquires the browsing information from the user terminal in the store, and the store terminal transmits the acquired browsing information to the management server, so that the management server executes the condition determination for granting the special gift, and the user terminal or the store terminal may be used instead of the management server. That is, even if the management server does not compare the browsing time with the current time to perform the condition determination, the user terminal, the store terminal, or any device constituting the system can perform the condition determination. As long as the system is configured to be able to determine whether or not the predetermined condition is satisfied by comparing the browsing time when the user browses the store information with the current time, any device may be used to determine whether or not a special gift can be granted.

In addition, in the second embodiment, for example, when the store terminal reads the browsing information, the browsing time included in the browsing information is displayed on the store terminal, or the browsing time included in the browsing information is displayed on the display screen of the user terminal, so that store staff can perform condition determination as to whether or not a predetermined condition is satisfied and determination as to whether or not a special gift can be granted by visual observation. In such a configuration, the store staff can determine whether or not a special gift can be granted to the user by comparing the time at which the user browses the store information with any of the time at which the user enters the store corresponding to the store information, the time at which the user places an order at the store, and the current time at which the browsing information is presented at the store. In addition, when the browsing time is displayed on the display screen of the user terminal so that the store staff can visually determine the granting, the special gift granting of the present system can also operate with the store terminal removed from the components.

With such a configuration, even in a store in which introduction of a POS system, a cash register system, or the like has not progressed so much, it is possible to grant a special gift to a user using the special gift granting system by determining whether or not to grant the special gift using visual observation of a store staff or the user himself/herself, and it is possible to expect improvement of a customer attracting effect by using the special gift granting system.

In the second embodiment, the timing of granting a special gift to a user, who is determined that a special gift can be granted to, is not particularly limited. Regarding the timing of granting a special gift, for example, whether or not to grant a special gift may be determined at the timing when it is identified that a user has entered the store corresponding to the browsed store information, and at the same time, a special gift that can be used at the store may be granted. In addition, the timing of granting a special gift may be, for example, a timing at which the user shows or presents the browsing information to the store or store staff at the store. In addition, as the timing of granting a special gift, for example, when the user enters the store, or when the user shows or presents the browsing information to the store or store staff, only the determination of whether or not to grant a special gift is performed first, and a special gift usable at the store may be granted at the timing when the user settles the payment at the store. Regarding the timing of granting a special gift, for example, when the user enters the store or when the browsing information is shown or presented to the store or store staff by the user, the management server may determine whether or not to grant a special gift, and based on the determination, the management server may communicate or transmit information regarding granting of a special gift to a settlement company with which the user makes a contract, and when the user settles the payment using the card of the settlement company or the like at the time of payment at the store, a special gift may be automatically granted to the settlement. With such a configuration, it is possible to provide a special gift granting service that is highly convenient for both the user and the store.

In the second embodiment, the browsing of the store information by the user terminal and the acquisition of the browsing information such as the code information and the browsing time are not limited to a case where the user terminal accesses or is used to browse the store information posted on the Web site on the Web server according to the present invention. For example, when the user terminal accesses or is used to browse store information posted on another server apparatus different from the Web server according to the special gift granting system and the user terminal receives store information or acquires browsing information from the another server apparatus, the management server according to the special gift granting system may be configured in a manner that the user terminal can receive or acquire the browsing history information related to the user browsing the store information from the another server apparatus. Then, it may be determined whether or not the user satisfies a predetermined condition for granting a special gift on the basis of the browsing information related to the browsing of the store information by the user acquired by the management server and/or the browsing history information received by the management server from the another server apparatus.

In such a configuration, it is preferable that the browsing history information received by the management server from the another server apparatus includes user identification information for identifying a user terminal that has accessed the store information posted on the another server apparatus, a browsing time of the store information by the user, identification information of the store corresponding to the store information, and the like. It is preferable to store information such as the user identification information, the browsing time, the identification information of the store in the database as the browsing history based on the browsing history information when the management server receives the browsing history information from the another server apparatus.

Further, in the second embodiment, the browsing history information may be provided to the Web server not only from the Web site on the Web server according to the special gift granting system but also from an external Web advertisement different from the system. With such a configuration, for example, even when a user browses an external Web advertisement where store information is posted, a browsing history can be created based on the provided browsing history information and stored in the database of the management server.

With such a configuration, for example, even when an advertisement or the like of the store including store information is displayed on a Web site on another server apparatus or an external Web advertisement while using the special gift granting system and a user visits the store due to browsing the store information, the user can be included in targets of customer attraction and marketing using the special gift granting system.

### Third Embodiment

Next, an outline of a third embodiment of the present invention will be described. According to the special gift granting system of the third embodiment, it is possible to determine whether or not to grant a special gift based on whether or not a condition of position information satisfies a predetermined condition, instead of determining whether or not to grant a special gift based on whether or not a predetermined condition as a temporal condition is satisfied.

The contents described in the first embodiment and the second embodiment can be adopted within a necessary range as the description related to the determination of whether or not to grant a special gift in the third embodiment. For specific configurations of the user terminal and the server apparatus, the contents related to the user terminal and the server apparatus described in the first embodiment and the second embodiment can be adopted within a necessary range.

In the second embodiment, whether or not to grant a special gift is determined based on whether or not a predetermined condition as a temporal condition is satisfied, but in the third embodiment, whether or not to grant a special gift can be determined based on position information instead of the temporal condition. That is, it is possible to compare the position information at the time when the user browses the store information with the position information at the time when the user approaches the store corresponding to the store information or at the time when the user enters the store, and to determine whether or not to grant a special gift based on whether or not the 2 pieces of position information satisfy a predetermined condition.

That is, in the third embodiment, as a method of identifying the position information of the user terminal, for example, the position information of the user terminal can be identified using the position information of the GPS sensor provided in the user terminal or a base station provided in a mobile communication network, and the condition determination in the special gift granting system according to the present invention can be performed.

In such a configuration, first, the position information at the time of browsing the store information is identified as the browsing information related to the user browsing the store information by using the position information of the GPS sensor provided in the user terminal or the base station provided in the mobile communication network, and is stored in the database of the server apparatus as the browsing history. Next, similarly, the position information of the user terminal is identified using the position information of the GPS sensor or the base station, and then, based on the position information of the store corresponding to the store information included in the store information browsed by the user, it is identified that the user has entered the store under the condition that the position information of the user terminal has approached the position information of the store or the position information of the user terminal has entered a predetermined range with respect to the position information of the store. When the user terminal owned by the user who has entered the store has, in the database as the browsing history of the server apparatus, the browsing information including the position information at the time when the store information related to the store is browsed at a position different from the position information of the store before entering the store, it is determined whether or not the position information included in the browsing information at the time of browsing the store information has a predetermined relation with the position information of the store included in the store information of the store. When the position information included in the browsing information at the time of browsing the store information has the predetermined relation with the position information of the store included in the store information of the store, it is determined that a special gift usable in the store can be granted to the user terminal. When it is determined that the position information included in the browsing information at the time when the user terminal owned by the user who has entered the store browses the store information does not have the predetermined relation with the position information of the store included in the store information of the store, it is determined that the user terminal cannot be granted a special gift usable in the store.

In the third embodiment, the predetermined relation on the position information is not particularly limited, and for example, the description of the use of the position information described in the first embodiment can be appropriately adopted. In addition, as the predetermined relation on the position information, for example, the description of the predetermined relation on the position in the fourth embodiment to be described later can be appropriately adopted.

In the third embodiment, as a method of identifying the position information of the user terminal, the case of using the position information of the GPS sensor provided in the user terminal and the base station provided in the mobile communication network has been described as an example, however, instead of using the position information of the GPS sensor and the base station provided in the mobile communication network, it is also possible to use the position information of the store corresponding to the browsed Web advertisement or the browsed store information to identify the position information of the user terminal and to perform the condition determination in the special gift granting system according to the present invention.

Specifically, first, for example, position information of a place or location where a Web advertisement posting a store information is arranged is included in the posted store information and/or code information as the position information of the Web advertisement and is configured to be acquirable by the user terminal. Next, when the user browses the store information posted on the Web advertisement, the store information and/or the code information is acquired through the user terminal. At this time, the position information of the Web advertisement included in the store information and/or the code information is included in the browsing information as the position information at the time when the user browses the store information, and is stored in the database as the browsing history. Next, the user acquires the position information of the store using the user terminal from the store terminal arranged in the store corresponding to the browsed store information or from code information such as a two-dimensional code including the position information of the store posted by the store. Through the acquisition of the position information of the store, it is identified from the position information that the user terminal has entered the store.

When the user terminal owned by the user identified as having entered the store has, as a browsing history of the server apparatus in the database, the browsing information including the position information at the time of browsing the store information related to the store at a position different from the position information of the store before entering the store, it is determined whether the position information included in the browsing information at the time of browsing the store information has the predetermined relation with the position information of the store included in the store information of the store. When the position information included in the browsing information at the time of browsing the store information has the predetermined relation with the position information of the store included in the store information of the store, it is determined that a special gift usable in the store can be granted to the user terminal. When it is determined that the position information included in the browsing information at the time when the user terminal owned by the user who has entered the store browses the store information does not have the predetermined relation with the position information of the store included in the store information of the store, it is determined that the user terminal cannot be granted a special gift usable in the store.

In the third embodiment, when a user enters a store corresponding to the store information, it is possible that the user terminal reads code information such as a QR code (registered trademark) posted in the store to acquire the position information of the store and identify that the user has entered the store, however, a method of acquiring position information of the store by the user terminal is not limited thereto. Regarding the method of acquiring the position information of the store by the user terminal, for example, the store may include a signal transmitting means for transmitting a signal such as sound, radio wave, light, or the like which can be acquired by the user terminal, wherein the position information of the store can be identified by the user terminal through receiving on the user terminal the signal such as sound, radio wave, light, or the like of a specific wavelength transmitted by the signal transmitting means.

In the third embodiment, the timing of granting a special gift is not particularly limited, and for example, the description regarding the timing of granting a special gift in the first embodiment and the second embodiment can be adopted within a necessary range.

In the third embodiment, the determination of whether or not to grant a special gift based on position information has been described as an example, however, it is also possible to determine whether or not a special gift can be granted to a user by using not only the determination of whether or not a special gift can be granted based on position information but also the determination of whether or not a special gift can be granted based on position information and the determination of whether or not a special gift can be granted based on a temporal condition in combination.

In the third embodiment, the position information related to the position at which the store information is browsed on the user terminal and the position information at the time when the user enters the store corresponding to the store information or when the user has entered the store corresponding to the store information are transmitted to the server apparatus, and the condition determination for granting the special gift is executed in the server apparatus, and it is also possible to perform execution processing for the condition determination for granting the special gift in the user terminal by activating a dedicated application installed in the user terminal instead of the server apparatus. That is, without performing the condition determination in the server apparatus, the position information at the time when the store information is browsed is stored in the user terminal by the background processing of the dedicated application in the user terminal and compared with the position information of the user terminal at the time when the user has entered the store corresponding to the store information or the position information of the store, thereby making it possible to determine whether or not to grant the special gift and to execute the special gift granting. In such a configuration, the position information at the time of browsing the store information and the position information at the time of entering the store corresponding to the store information may be transmitted from the user terminal to the server apparatus to store the respective position information as a history, and the server apparatus may assist the condition determination by the dedicated application on the user terminal. Alternatively, the user terminal may transmit only the information about the result of the determination as to whether or not to grant the special gift without transmitting the position information to the server apparatus from the user terminal, and the server apparatus side may manage only the result of the determination as to whether or not to grant the special gift.

### Fourth Embodiment

Next, an outline of a fourth embodiment of the present invention will be described. According to the special gift granting system of the fourth embodiment, when the user approaches the store corresponding to the store information browsed by the user, it is possible to notify the user terminal that there is a special gift that can be granted.

The contents described in the first embodiment, the second embodiment, and the third embodiment can be adopted within a necessary range for the description related to the determination of whether or not to grant a special gift in the fourth embodiment. For specific configurations of the user terminal and the server apparatus, the contents related to the user terminal and the server apparatus described in the first embodiment, the second embodiment, and the third embodiment can be adopted within a necessary range.

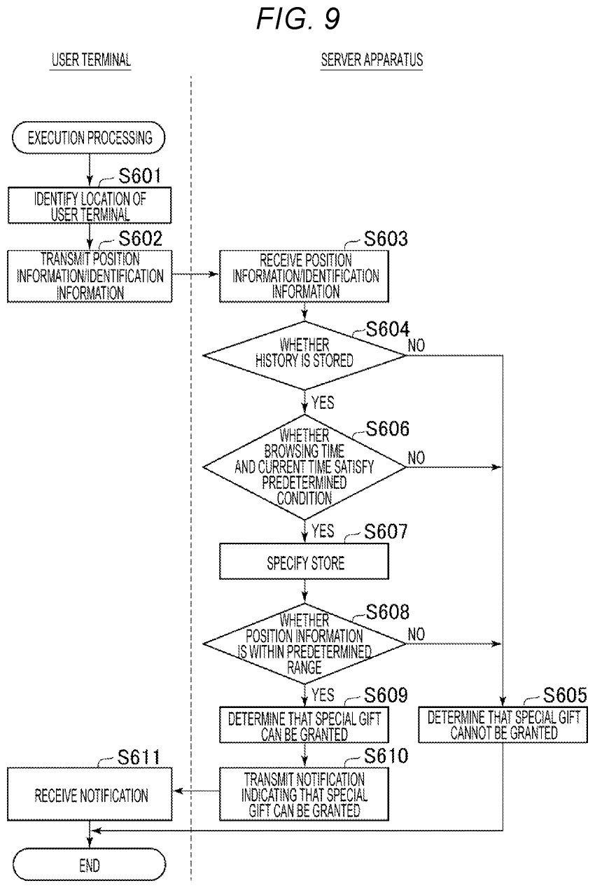

Hereinafter, an execution processing of notifying a user terminal of special gift granting in the special gift granting system according to the present invention will be described. FIG. 9 is a diagram illustrating a flowchart of an execution processing of notifying a user terminal of special gift granting in the special gift granting system according to an embodiment of the present invention.

In the fourth embodiment, when a user visits the vicinity of a store corresponding to store information or has entered the store, a user terminal owned by the user who has browsed the store information on the server apparatus provided in the special gift granting system can be notified that a special gift usable in the store has been granted or can be granted.

First, in the server apparatus, user identification information for identifying a user or a user terminal, browsing time of store information by the user terminal, identification information of a store corresponding to the store information, and the like are stored in advance as a browsing history in a history storage database with respect to the user terminal owned by the user who has browsed the store information posted on a Web site on the server apparatus.

In the following, on the assumption that the browsing history of the user is stored in the history storage database, an execution processing for notifying the user terminal of the special gift granting will be described in order. The user terminal of the user who has browsed the store information on the server apparatus in advance identifies the position information of the user terminal by a locater such as GPS (step S601). Next, the user terminal transmits the identified position information to the server apparatus together with the user identification information (step S602).

In identifying the position information and transmitting the position information to the server apparatus, an application for using the special gift granting system is downloaded to the user terminal, and the application downloaded to the user terminal is activated so that the position information can be transmitted from the user terminal to the server apparatus together with the user identification information. Examples of the user identification information include a MAC address as a terminal identification information of the user terminal and a user ID, etc. in a case where the user is registered in advance as a user of a service using the special gift granting system. When the user terminal accesses store information on another server apparatus which is different from the server apparatus of the special gift granting system, an IP address or the like for accessing the store information may be used as the user identification information.

When the server apparatus receives the position information and the user identification information from the user terminal (step S603), the server apparatus this time identifies whether or not a browsing history having user identification information corresponding to or coinciding with the user identification information received in step S603 is stored in advance in the history storage database (step S604). When the browsing history is stored in advance in the history storage database in step S604 (Yes in step S604), it is then determined whether or not the user terminal satisfies a condition for granting a special gift. In step S604, when the corresponding history is not stored in the database (No in step S604), the server apparatus determines that the special gift cannot be granted to the user terminal (step S605), and ends the execution processing.

In the case of Yes in step S604, the server apparatus, in the condition determination for granting a special gift, first compares the access time of the user terminal to the server apparatus or the browsing time during which the user browses the store information corresponding to the browsing history identified in step S604 with the current time to determine whether or not the predetermined condition is satisfied (step S606).

Here, as the current time in step S606, for example, the time at which the server apparatus receives the position information and the user identification information from the user terminal in step S603 can be adopted. In addition, for example, the latest time at which the server apparatus determines the condition for granting a special gift to the user terminal may be adopted.

The predetermined condition in step S606 may be, for example, a condition that the current time has passed a predetermined time from the browsing time when the browsing time and the current time are compared with each other. Further, for the predetermined condition and the predetermined time, the description related to the predetermined condition and/or the predetermined time in the first embodiment and the second embodiment can be adopted within a necessary range.

When the predetermined condition is satisfied in step S606 (Yes in step S606), the server apparatus identifies store information and/or a store corresponding to the browsing history on the basis of the browsing history identified in step S604 (step S607). When the predetermined condition is not satisfied in step S606 (No in step S606), it is determined that the special gift cannot be granted to the user terminal (step S605), and the execution processing is ended.

For identifying the store information and/or the store corresponding to the browsing history in step S607, more specifically, for example, the server apparatus identifies the position information of the store registered in advance for the store information and/or the store corresponding to the browsing history.

The server apparatus that has identified the position information of the store in step S607 subsequently determines whether or not the position information received from the user terminal in step S603 has a predetermined relation with the position information of the store identified in step S607 (step S608). The predetermined relation is not particularly limited, for example, the fact that the position information received in step S603 is within a predetermined range with respect to the position information of the store identified in step S607 can be adopted as a condition. In addition, the predetermined range is not particularly limited, but from the viewpoint of allowing the user to recognize that the user has approached or entered a store, in which a special gift can be granted, corresponding to the store information browsed by the user in advance, for example, the position information received in step S603 is preferably within 20 m with respect to the position information of the store, and more preferably within 10 m.

When it is determined in step S608 that there is the predetermined relation (Yes in step S608), the server apparatus determines that a special gift can be granted to the user terminal or that there is a special gift that can be granted to the user terminal (step S609), and transmits a granting information notifying that a special gift can be granted to the user terminal (step S610).

When it is determined in step S608 that there is not the predetermined relation (No in step S608), the server apparatus determines that the special gift cannot be granted to the user terminal (step S605), and ends the execution processing without transmitting the granting information.

Finally, the user terminal receives the granting information from the server apparatus (step S611), and ends the execution processing.

In the fourth embodiment, by notifying a user or a user terminal that a special gift usable in a nearby store or a store that has been entered is granted using a locating function such as GPS, browsing of store information and use of the special gift granted thereby can be promoted, and the effect of attracting customers by granting a special gift using the special gift granting system can be further enhanced.

In the fourth embodiment, the predetermined condition for granting a special gift is that the user has browsed the store information on the server apparatus using a user terminal before the user terminal transmits the position information, however, the predetermined condition is not limited to having browsed the store information. For example, displaying the store information on the display screen of the user terminal may be adopted as the predetermined condition for granting the special gift.

In addition, in the fourth embodiment, about the predetermined condition for granting the special gift, the browsing time of the store information is not particularly limited, and for example, the description on the browsing time in the second embodiment can be adopted within a necessary range. In addition, for example, the browsing position of the store information is not particularly limited, and for example, when the special gift granting system is used to promote customer attraction in a theme park or the like, the browsing position may be limited to the site of the theme park.

In the fourth embodiment, as code information, a one-dimensional code or a two-dimensional code is adopted as an example, but the information is not limited thereto as long as the browsing information indicating that the user terminal has accessed the server apparatus or the store information can be identified. For example, instead of the code information, a voice pattern, a frequency pattern, or the like that can be used to identify the user identification information, the browsing time, the store information, or the like may be generated on the Web site, acquired by the user terminal, and used as the browsing information.

The special gift granting system according to the present invention is primarily assumed to be used in business situations where a customer attracting effect can be expected using a discount coupon or the like that can be used to purchase a service or a commodity in an actual store, for example, in restaurants, stores, and the like. However, the business area to which the special gift granting system according to the present invention is applicable is not limited to these. For example, the present invention can also be appropriately applied to plans and businesses in which a special gift is granted to a user to increase a customer attracting effect in the improvement of facility use situation or customer attraction to an event or the like in an entertainment facility such as karaoke or amusement facility.

### REFERENCE SIGNS LIST

1 USER TERMINAL
2 COMMUNICATION NETWORK
3 SERVER APPARATUS
4 USER
5 GPS SATELLITE
11 CONTROLLER
12 RAM
13 STORAGE
14 SENSOR UNIT
15 GRAPHICS PROCESSOR
16 COMMUNICATION INTERFACE
17 INTERFACE UNIT
18 DISPLAY UNIT
19 IDENTIFICATION INFORMATION ACQUISITION UNIT
31 CONTROLLER
32 RAM
33 STORAGE
34 COMMUNICATION INTERFACE

1. A special gift granting system for granting a special gift to a user, the special gift granting system comprising:
a user terminal carried by a user; and
a server apparatus capable of communication connection with a user terminal,
wherein the user terminal includes:
a browsing request transmitter that transmits a store information browsing request and user identification information that can identify the user or the user terminal to the server apparatus;
a store information receiver that receives store information from the server apparatus;
a special gift request information acquirer that acquires a special gift request information for receiving a special gift at a store; and
a special gift request information transmitter that transmits the acquired special gift request information and the user identification information to the server apparatus, and
wherein the server apparatus includes:
a browsing request receiver that receives the browsing request and the user identification information from the user terminal;
a store information transmitter that transmits the store information to the user terminal;
a history information storage that stores a history related to receiving the browsing request from the user terminal or transmitting the store information to the user terminal in association with the user identification information corresponding to the user terminal;
a special gift request information receiver that receives the special gift request information and the user identification information from the user terminal;
a history determiner that determines whether the history corresponding to the received user identification information is stored in the history information storage; and
a first special gift granting enabler that enables granting of the special gift to the user when the history determiner determines that the history corresponding to the received user identification information is stored.

2. The special gift granting system according to claim 1, wherein
the user terminal further includes:
a locater that locates the user terminal; and
a position information transmitter that transmits position information related to a located position when the browsing request transmitter transmits the store information browsing request,
the server apparatus further includes:
a position information receiver that receives the position information from the user terminal; and
a position determiner that determines whether the position information received by the position information receiver is outside a predetermined range with respect to the position information of the store or the position information related to the located position at a time when the special gift request information is transmitted by the special gift request information transmitter, wherein
the first special gift granting enabler enables granting of the special gift to the user when the position determiner determines that the position information is outside the predetermined range and the history determiner determines that the history corresponding to the received user identification information is stored.

3. The special gift granting system according to claim 1, wherein
the history information storage stores a time at which the browsing request is received from the user terminal or a time at which the store information is transmitted to the user terminal,
the special gift granting system further comprises:
a time determiner that determines whether an elapsed time from a time at which the browsing request is received from the user terminal or a time at which the store information is transmitted to the user terminal to a time at which the special gift request information is received from the user terminal is within a predetermined time, and
the first special gift granting enabler enables granting of the special gift to the user when the time determiner determines that the elapsed time is within the predetermined range and the history determiner determines that the history corresponding to the received user identification information is stored.

4. The special gift granting system according to claim 1, wherein
the server apparatus further includes a special gift drawer that draws one or more special gifts from among a plurality of different special gifts, and
the first special gift granting enabler enables the special gift selected through drawing to be granted to the user terminal.

5. A special gift granting system for granting a special gift to a user, the special gift granting system comprising at least one computer device, wherein
the computer device includes:
a first browsing information acquirer that acquires a browsing information including a browsing time at which the user browses a store information; and
a browsing information displayer that displays the acquired browsing information, and
wherein a condition for granting a special gift to the user is that the browsing time satisfies a predetermined condition.

6. The special gift granting system according to claim 5, wherein the browsing information is a one-dimensional code or a two-dimensional code.

7. The special gift granting system according to claim 5, wherein
the computer device is a user terminal owned by the user,
the special gift granting system further comprising a store terminal used in a store,
the store terminal includes a second browsing information acquirer that acquires the browsing information from the user terminal, and
the special gift granting system further comprising a condition determiner that determines whether the browsing time included in the browsing information satisfies the predetermined condition for granting the special gift to the user.

8. A special gift granting system for granting a special gift to a user, the special gift granting system comprising at least a user terminal owned by the user, wherein
the user terminal includes a store information displayer that displays a store information,
the special gift granting system further comprising:
a locater that locates the user terminal;
a condition determiner that determines whether a predetermined condition for granting a special gift to the user is satisfied; and
a second special gift granting enabler that enables granting of the special gift to the user terminal when it is determined that the predetermined condition is satisfied and a located position has a predetermined relation with a position of a store corresponding to the displayed store information, and
the predetermined condition is that the user terminal displays the store information.

9. The special gift granting system according to claim 8, further comprising:
a granting information notifier that notifies the user terminal that the special gift can be granted when granting of the special gift to the user terminal is enabled by the second special gift granting enabler.

10. A special gift granting system comprising:
a user terminal owned by a user;
a store terminal used in a store; and
a server apparatus capable of communication connection with the user terminal and the store terminal, wherein
the user terminal includes:
a store information displayer that displays store information;
a browsing information acquirer that acquires browsing information related to browsing of the store information by the user; and
a browsing information displayer that displays the acquired browsing information, the store terminal includes:
a browsing information reader that reads the browsing information displayed on the user terminal; and
a browsing information transmitter that transmits the read browsing information to the server apparatus, and
the server apparatus includes:
a browsing information receiver that receives the browsing information from the store terminal; and
a condition determiner that determines whether a predetermined condition for granting a special gift to the user is satisfied based on the received browsing information.

11. The special gift granting system according to claim 10, wherein
the user terminal further includes a store information receiver that receives the store information from another server apparatus,
the browsing information acquirer acquires the browsing information from the another server apparatus,
the server apparatus includes
a browsing history information receiver that receives browsing history information related to browsing of the store information by the user from the another server apparatus, and
the condition determiner determines whether the predetermined condition for granting the special gift to the user is satisfied based on the received browsing information and the browsing history information.

12. A special gift granting apparatus capable of communication connection with a user terminal carried by a user, the special gift granting apparatus comprising:
a browsing request receiver that receives a store information browsing request and user identification information, which can identify the user or the user terminal, from the user terminal;
a store information transmitter that transmits the store information to the user terminal;
a history information storage that stores a history related to receiving the browsing request from the user terminal or transmitting the store information to the user terminal in association with the user identification information corresponding to the user terminal;
a special gift request information receiver that receives a special gift request information for receiving a special gift at a store and the user identification information from the user terminal;
a history determiner that determines whether the history corresponding to the received user identification information is stored in the history information storage; and
a first special gift granting enabler that enables granting of the special gift to the user when the history determiner determines that the history corresponding to the received user identification information is stored.

13. A special gift granting method executed in a special gift granting system that includes a user terminal carried by a user and a server apparatus capable of communication connection with the user terminal and grants a special gift to the user, wherein:
the user terminal performs the operations of:
transmitting a store information browsing request and user identification information that can identify the user or the user terminal to the server apparatus;
receiving store information from the server apparatus;
acquiring a special gift request information for receiving a special gift at a store; and
transmitting the acquired special gift request information and the user identification information to the server apparatus, and
the server apparatus performs the operations of:
receiving the browsing request and the user identification information from the user terminal;
transmitting the store information to the user terminal;
storing a history related to receiving the browsing request from the user terminal or transmitting the store information to the user terminal in association with the user identification information corresponding to the user terminal;
receiving a special gift request information and the user identification information from the user terminal;
determining whether the history corresponding to the received user identification information is stored in the storing; and
enabling granting of the special gift to the user when determining that the history corresponding to the received user identification information is stored.

14. A special gift granting method executed in a special gift granting system that includes at least one computer device and is for granting a special gift to a user, wherein:
the computer device performs the operations of:
acquiring browsing information including a browsing time at which the user browses store information; and
displaying the acquired browsing information, wherein
a condition for granting a special gift to the user is that the browsing time satisfies a predetermined condition.

15. A special gift granting method executed in a special gift granting system that includes at least a user terminal owned by a user and is for granting a special gift to the user, wherein:
the user terminal performs the operations of:
displaying store information, and the special gift granting method comprising:
locating the user terminal;
determining whether a predetermined condition for granting a special gift to the user is satisfied; and
enabling granting of the special gift to the user terminal when it is determined that the predetermined condition is satisfied and a located position has a predetermined relation with a position of a store corresponding to the displayed store information, wherein
the predetermined condition is that the user terminal displays the store information.

16. A special gift granting method executed in a special gift granting system that includes a user terminal owned by a user; a store terminal used in a store; and a server apparatus capable of communication connection with the user terminal and the store terminal, wherein:
the user terminal performs the operations of:
displaying store information;
acquiring browsing information related to browsing of the store information by the user; and
displaying the acquired browsing information,
the store terminal performs the operations of:
reading the browsing information displayed on the user terminal; and
transmitting the read browsing information to the server apparatus, and
the server apparatus performs the operations of:
receiving the browsing information from the store terminal; and
determining whether a predetermined condition for granting a special gift to the user is satisfied based on the received browsing information.

17. A non-transitory computer-readable recording medium storing a special gift granting program executed on a user terminal in a special gift granting system that includes at least the user terminal owned by a user and is for granting a special gift to the user, wherein
the special gift granting program causes the user terminal to function as:
a store information displayer that displays a store information;
a locater that locates the user terminal;
a condition determiner that determines whether a predetermined condition for granting a special gift to the user is satisfied; and
a second special gift granting enabler that enables granting of the special gift to the user terminal when it is determined that the predetermined condition is satisfied and a located position has a predetermined relation with a position of a store corresponding to the displayed store information, wherein
the predetermined condition is that the user terminal displays the store information.
